(19) United States
(12) Patent Application Publication
(10) Pub. No.: US 2021/0383680 A1
(43) Pub. Date: Dec. 9, 2021

(54) SYSTEM AND METHOD FOR CONTROLLING OPERATION OF AN ELECTRIC DEVICE

(71) Applicants: Defond Electech Co., Ltd., Guangdong (CN); Defond Components Limited, Chai Wan (HK)

(72) Inventors: Cheng Chen Nieh, Chai Wan (HK); Chiu Keung Loong, Chai Wan (HK); Xiaoling Liu, Chai Wan (HK); Chun Kan Lin, Chai Wan (HK)

(21) Appl. No.: 17/337,722

(22) Filed: Jun. 3, 2021

(30) Foreign Application Priority Data
Jun. 3, 2020 (HK) 32020008583.7

(51) Int. Cl. G08C 17/02; H04B 1/3827

(52) U.S. Cl. CPC G08C 17/02; H04B 1/385

(57) ABSTRACT

A system for controlling operation of an electric device includes the electric device, at least one contactless sensor module connected to the electric device, and a wearable item equipped with a sensor-readable tag configured for contactless interaction with the contactless sensor of the electric device. The tag is configured for movement with the wearable item into a plurality of different positions relative to the contactless sensor, and the contactless sensor is configured to sense different sensor readings in response to movement of the tag into the plurality of different positions. The electric device is configured to enter a first operating mode in response to the contactless sensor sensing a first position of the tag, and to enter a second operating mode in response to the contactless sensor sensing a second position of the tag.

### CROSS REFERENCE TO RELATED APPLICATIONS

This application claims the priority benefit of Hong Kong Short Term Patent Application No. 32020008583.7 filed 3 June 2021 for Defond Components Limited, hereby incorporated by reference in its entirety as though fully set forth herein.

### TECHNICAL FIELD

The subject matter described herein relates to systems and methods for controlling operation of electric devices such as electric power tools, electric gardening tools, electric vehicles and the like.

### BACKGROUND

When an inexperienced user operates an electric power tool, he/she risks causing injury to themselves, for instance by improperly holding the power tool. Even if injury is not caused, the a poorly handled electric power tool will result in inefficient and ineffective usage of the tool, damage to the materials being modified by the tool, etc. Unfortunately, there does not currently exist any effective way to address such problems. Accordingly, need exists for devices, methods, and systems that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is an electric device access control system that seeks to alleviate at least one of the above-described problems. The electric device access control system disclosed herein has particular, but not exclusive, utility for safely controlling access to tools, to limit operation by an untrained or unauthorized person. In accordance with at least one embodiment of the present disclosure, devices, systems, and methods are provided which control, restrict, or enable the operation of electric devices such as power tools, gardening tools, electric vehicles and the like. The system may for example include a wearable item (e.g., a glove) incorporating a sensor-readable element such as an NFC or RFID tag, and a contactless sensor module (e.g., an NFC or RFID tag reader) connected to the electric device (e.g., a power tool). The tag enables contactless-interaction with the contactless sensor of the electric device, to enable power to the device only when the tag is in proximity to the sensor. The present invention may involve several broad forms. Embodiments of the present invention may include one or any combination of the different broad forms herein described.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for controlling operation of an electric device. The system includes an electric device; at least one contactless-type sensor module operably connected to the electric device; a wearable item having at least one sensor-readable element disposed therein, said sensor-readable element being configured for contactless interaction with the contactless-type sensor of the electric device, said at least one sensor-readable element being configured for movement with the wearable item into a plurality of different positions relative to the at least one contactless-type sensor of the electric device, where the contactless-type sensor is configured to sense a plurality of different sensor readings in response to movement of the at least one sensor-readable element into the plurality of different positions. The electric device is configured to enter a first operating mode in response to the at least one contactless-type sensor sensing a first sensor reading when the at least one sensor-readable element is arranged in a first position relative to the at least one contactless-type sensor, and where, the electric device is configured to enter a second operating mode in response to the at least one contactless-type sensor sensing a second sensor reading when the at least one sensor-readable element is arranged in a second position relative to the at least one contactless-type sensor. Other embodiments of this aspect include corresponding computer systems, apparatus, and computer programs recorded on one or more computer storage devices, each configured to perform the actions of the methods.

Implementations may include one or more of the following features. A system as claimed where the first operating mode includes normal operation of the electric device, and the second operating mode includes non-operation of the electric device. In some embodiments, when the electric device is configured to be in first or second operating mode, the electric device is configured to be in the first or second operating mode for a specific time period. In some embodiments, when the at least one sensor-readable element is arranged in the first position relative to the at least one contactless-type sensor, the wearable item is engaged with a user-engagement portion of the electric device in a predetermined configuration, and, when the at least one sensor-readable element is arranged in the second position relative to the at least one contactless-type sensor, the wearable item is not engaged with the user-engagement portion of the electric device in the predetermined configuration. In some embodiments, the user-engagement portion includes a handle of the electric device. In some embodiments, the electric device includes at least one of an electric power tool, an electric gardening tool or a vehicle. In some embodiments, the wearable item includes at least one of a glove, a bracelet, a ring, a hat, a shirt, or a watch. In some embodiments, the wearable item includes a plurality of sensor-readable elements disposed thereon and the electric device includes a plurality of corresponding contactless-type sensor modules operably-connected therewith. In some embodiments, the contactless-type sensor module is operably-connected with a switch module of the electric device, said switch module being operable in a first operational state responsive to the contactless-type sensor sensing the first sensor reading where power from a power supply of the electric device is able to be delivered to an electric motor of the electric device via the switch module so that the electric device is operable, and, a second operational state responsive to the contactless-type sensor sensing the second sensor reading where power from the power supply of the electric device is not able to be delivered to the electric motor of the electric device via the switch module. In some embodiments, the at least one contactless-type sensor module includes a near field communication (NFC) type sensor module. In some embodiments, the sensor-readable element is disposed in a tag disposed on the wearable item. In some embodiments, the tag is removably attachable to the wearable item. In some embodiments, the first sensor reading is sensed by the at least one contactless-type sensor when both the at least one sensor-readable element is arranged in the first position relative to the at least one contactless-type sensor, and, when the at least one contactless-type sensor reads an identification data stored in the at least one sensor-readable element and an authentication module operably connected with the at least one contactless-type sensor determines that the identification data meets a predetermined criterion. In some embodiments, the authentication module is programmable to customise the predetermined criterion. In some embodiments, the first or second operating mode includes non-operation of selected features of the electric device. Some embodiments include a non-transitory computer-readable storage medium storing instructions, which when executed by at least one processor of a computer system, causes the computer system to carry out the sensing and entering steps of the system. Some embodiments include a computer-readable medium carrying instructions, which when executed by at least one processor of a computer system, causes the computer system to carry out the sensing and entering steps of the system. Some embodiments include a computer system including: one or more processors; and a storage medium storing instructions, which when executed by at least one processor, cause the system to implement the sensing and entering steps of the system. Implementations of the described techniques may include hardware, a method or process, or computer software on a computer-accessible medium.

One general aspect includes a wearable item for use in controlling operation of an electric device where at least one contactless-type sensor module is operably connected with the electric device. The wearable item also includes at least one sensor-readable element disposed on the wearable item, said sensor-readable element being configured for contactless interaction with the contactless-type sensor of the electric device. The wearable item also includes said at least one sensor-readable element being configured for movement with the wearable item into a plurality of different positions relative to the at least one contactless-type sensor of the electric device where the contactless-type sensor is configured to sense a plurality of different sensor readings in response to movement of the at least one sensor-readable element into the plurality of different positions. The electric device is configured to be in a first operating mode in response to the at least one contactless-type sensor sensing a first sensor reading when the at least one sensor-readable element is arranged in a first position relative to the at least one contactless-type sensor, and where, the electric device is configured to be in a second operating mode in response to the at least one contactless-type sensor sensing a second sensor reading when the at least one sensor-readable element is arranged in a second position relative to the at least one contactless-type sensor. Other embodiments of this aspect include corresponding computer systems, apparatus, and computer programs recorded on one or more computer storage devices, each configured to perform the actions of the methods.

One general aspect includes an electric device controllable by a wearable item, where at least one sensor-readable element is disposed on the wearable item, said sensor-readable element being configured for contactless-interaction with the contactless-type sensor of the electric device. Said at least one sensor-readable element is configured for movement with the wearable item into a plurality of different positions relative to the at least one contactless-type sensor of the electric device where the contactless-type sensor is configured to sense a plurality of different sensor readings in response to movement of the at least one sensor-readable element into the plurality of different positions. The electric device is configured to be in a first operating mode in response to the at least one contactless-type sensor sensing a first sensor reading when the at least one sensor-readable element is arranged in a first position relative to the at least one contactless-type sensor, and the electric device is configured to be in a second operating mode in response to the at least one contactless-type sensor sensing a second sensor reading when the at least one sensor-readable element is arranged in a second position relative to the at least one contactless-type sensor. Other embodiments of this aspect include corresponding computer systems, apparatus, and computer programs recorded on one or more computer storage devices, each configured to perform the actions of the methods.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the electric device access control system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 shows a functional block diagram of a system for use in controlling operation of an electric power tool, in accordance with at least one embodiment of the present disclosure;

FIG. 2 shows another functional block diagram of the system, in accordance with at least one embodiment of the present disclosure.

FIG. 3A shows a wearable item in the form of a glove having an NFC tag disposed therein, in accordance with at least one embodiment of the present disclosure.

FIG. 3B shows an example power tool, in accordance with at least one embodiment of the present disclosure.

FIG. 3C shows two views of an example power tool which includes a sensing area, in accordance with at least one embodiment of the present disclosure.

FIG. 4 shows a further functional block diagram of the system, in accordance with at least one embodiment of the present disclosure.

FIG. 5 shows a representation of the contactless interaction between the NFC sensor module and the NFC tag of the system, in accordance with at least one embodiment of the present disclosure.

FIG. 6 is a schematic diagram of a processor circuit according to embodiments of the present disclosure.

### DETAILED DESCRIPTION

In accordance with at least one embodiment of the present disclosure, devices, systems, and methods are provided which control, restrict, or enable the operation of electric devices such as power tools, gardening tools, electric vehicles and the like. Certain embodiments of the present disclosure may utilize a single contactless-type sensor module (e.g. a single NFC type sensor) which may be configured for receiving sensor readings from one or more different sensor readable elements.

The electric device access control system provides a system for controlling operation of an electric device. The system may for example include a contactless sensor module (e.g., an NFC or RFID tag reader) connected to the electric device, and a wearable item (e.g., a glove) incorporating a sensor-readable element such as an NFC or RFID tag. The tag enables contactless-interaction with the contactless sensor of the electric device, even while the tag moves through a plurality of different positions and orientations relative to the contactless sensor. In some cases, such movements may be explicitly detected, and used to control the electric device. The electric device changes state (e.g., from an inoperable to an operable state) in response to the contactless sensor sensing it is in proximity to the sensor-readable element, and to change state again (e.g., from an operable to an inoperable state) when the sensor-readable element is no longer in proximity

The present disclosure aids substantially in the safe, secure operation of power tools and other potentially hazardous devices, by improving a device's ability to refuse operation to an unauthorized user (e.g., a child or untrained adult). Implemented on a processor in communication with the sensor, the electric device access control system disclosed herein provides practical security authorization to potentially dangerous machinery. This improved device security transforms a potentially dangerous device into one that is only operable by authorized personnel, without the normally routine need to include physical security measures such as key locks. This unconventional approach improves the functioning of the device, by restricting its operation to users who are trained or otherwise authorized.

Any one of the features of the embodiments described herein referred to as a “module” may be implemented in software for execution by various types of processors. An identified module of executable code may, for instance, comprise one or more physical or logical blocks of computer instructions which may, for instance, be organized as an object, procedure, function, or algorithm. The identified blocks of computer instructions need not be physically located together, but may comprise disparate instructions stored in different locations which, when joined logically together, comprise the module and achieve the stated purpose for the module. A module may also be implemented as a hardware circuit comprising custom circuits or gate arrays, off-the-shelf semiconductors such as logic chips, transistors, or other discrete components. A module may also be implemented in programmable hardware devices such as field programmable gate arrays, programmable array logic, programmable logic devices or the like. A module of executable code may comprise a single instruction, multiple instructions, and may be distributed over several different code segments, among different programs, and across several discrete memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The reference to any related art in this specification is not, and should not be taken as, an acknowledgment or any form of suggestion that that related art forms part of the common general knowledge. These descriptions are provided for exemplary purposes only, and should not be considered to limit the scope of the electric device access control system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

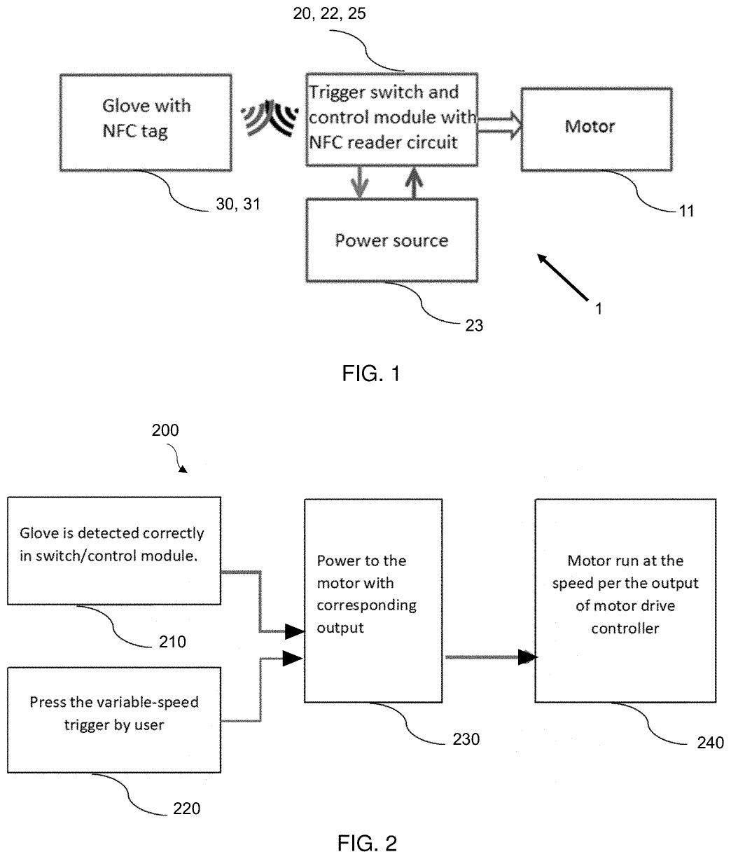

FIG. 1 shows a functional block diagram of at least a portion of a system 1 for use in controlling operation of an electric power tool, in accordance with at least one embodiment of the present disclosure. In the example shown in FIG. 1, the electric device access control system 1 comprises an electric motor 11, a battery or power source 23, a glove or other wearable article 30 which contains a sensor-readable element 31 such as an NFC or RFID tag, a contactless-type sensor module 20, a control module or controller module 22, and a trigger assembly 25.

FIG. 2 shows a flow diagram of a method 200 in accordance with at least one embodiment of the present disclosure. In step 210, the control module or switch/control module detects the presence of the sensor-readable element (e.g., NFC or RFID tag) within the wearable article (e.g., glove), and enables power to be supplied to the motor. In step 220, a trigger, button, variable-speed trigger, etc. is pressed by a user. In step 230, the combination of the tag detection in step 210 and trigger activation in step 220 causes power to flow into the motor. The amount of power may for example be proportional to the amount of trigger press. In step 240, under the influence of a motor drive controller or similar apparatus, the motor of the tool (or other electrical device) runs at a speed proportional to the power supplied in step 230.

It is understood that the steps of method 200 may be performed in a different order than shown in FIG. 2, additional steps can be provided before, during, and after the steps, and/or some of the steps described can be replaced or eliminated in other embodiments. One or more of steps of the method 200 can be carried by one or more devices and/or systems described herein, such as components of the electric device access control system 1, and/or processor circuit 650.

It should be appreciated and understood that whilst the embodiments are described for use with an electric power tool having a variable-speed trigger assembly, this is merely for illustrating an example application of the inventive concept. Alternate embodiments of the present disclosure may be suitably adapted for use with other types of electric devices such as gardening tools, home appliances and vehicles. Furthermore, whilst embodiments of the present disclosure described herein refer to electric devices comprising an electric motor, it would be appreciated that alternate embodiments of the present disclosure may also be applicable to electric devices which comprise a solenoid type electro-mechanical unit to effect operable movement (e.g. reciprocal motion) of the electric device.

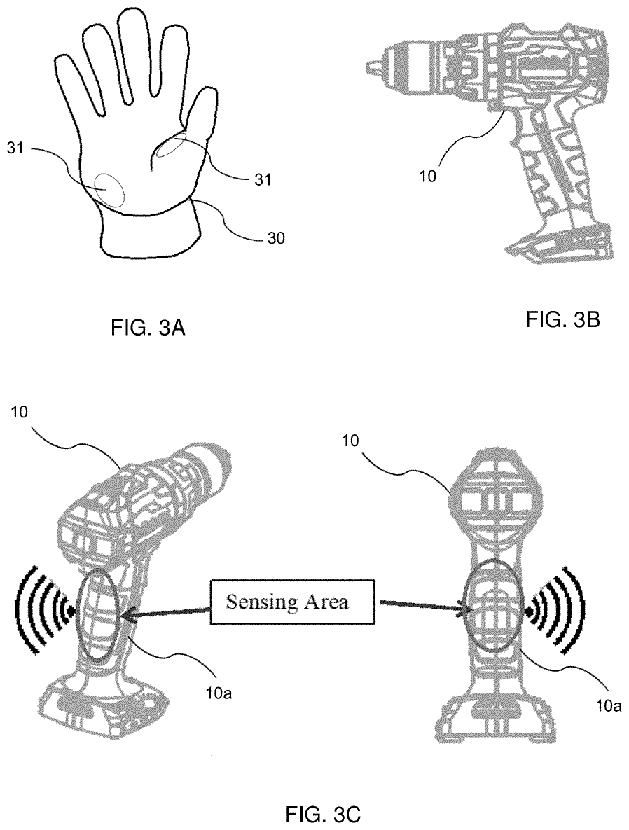

FIG. 3A shows a wearable item 30 in the form of a glove having one or more sensor-readable elements 31 in the form of NFC tags disposed therein, in accordance with an embodiment of the present disclosure. In an example, an NFC tag may be sensed by an NFC sensor module disposed in a handle of an electric power tool.

FIG. 3B shows an example power tool 10, in accordance with at least one embodiment of the present disclosure. For instance the electric power tool (10) may be, may include, or may comprise at least a portion of an electric drill, grinder, sander, saw, rotary driving tool, or other power tool, gardening tool, vehicle, or other electric device.

FIG. 3C shows two views of an example power tool 10 which includes a sensing area 10a, in accordance with at least one embodiment of the present disclosure. The sensing area 10a may for example include at least a portion of, or be in electrical or signal contact with, a contactless sensor module as described below.

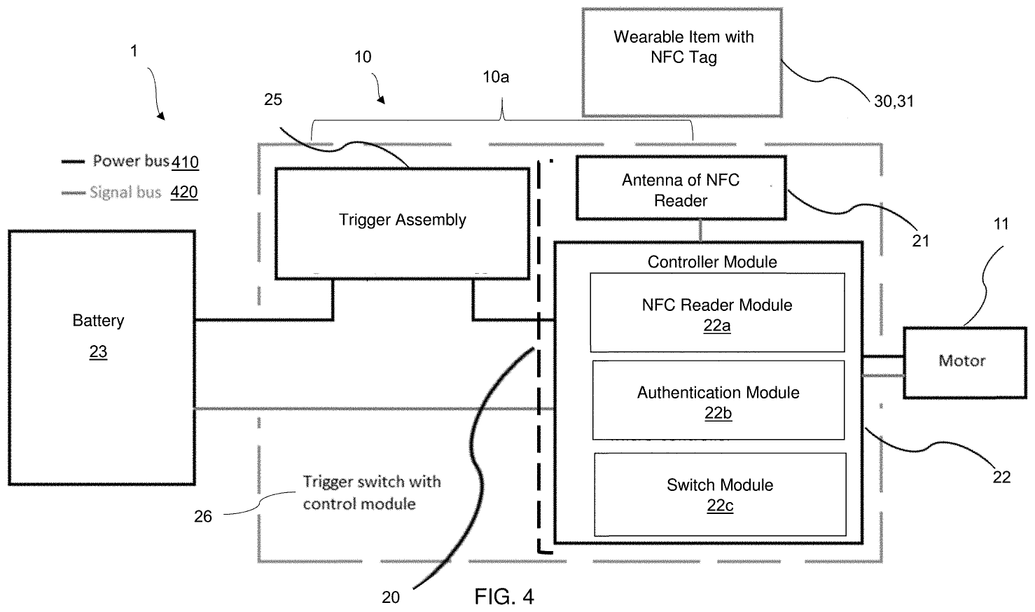

FIG. 4 shows a further functional block diagram of at least a portion of an example electric device access control system 1, in accordance with at least one embodiment of the present disclosure. In the example shown in FIG. 4, a contactless-type sensor module 20 is disposed in the electric power tool. More specifically, an NFC-type sensor module may be used, although it is possible that other types of contactless sensor technologies could be employed in alternate embodiments. In an example, the sensor module 20 is located in a handle 10a of a power tool and comprises an NFC sensor antenna 21 that is operably connected via circuitry with a controller module 22 having an NFC reader module 22a, an authentication module 22b and a switch module 22c. The controller module may also include other functional modules including a power management circuit module, voltage and current sensing modules, a solid state device driving circuit module, a trigger sensing module, a micro-controller module, and a battery management module. The switch module 22c is disposed on an electric circuit path between a battery 23 and an electric motor 11 of the power tool 10. The switch module 22c is configured for operation in at least one of a closed state and an opened state in response to different sensor reading signals received from the NFC reader module from the NFC antenna. When arranged in the closed state, the switch module 22c is configured to enable flow of power from the battery 23 to the electric motor 11 via the switch module 22c, and, when arranged in the opened state, the switch module 22c is configured to prevent flow of power from the battery 23 to the electric motor 11 via the switch module 22c. In an example, the antenna 21, controller module 22, NFC reader module 22a, authentication module 22b, and switch module 22c of the sensor module 20, along with the battery 23, trigger assembly 25, and motor 11, are parts of, or are connected to, a power bus 410. In an example, the trigger assembly 25, trigger switch control module 26, and antenna 21, controller module 22, NFC reader module 22a, authentication module 22b, and switch module 22c of the sensor module 20 are parts of, or are connected to, a signal bus 420.

The NFC tag 31 may for example be rigidly or flexibly attached to the palm region of the glove 30 as shown in FIG. 3A, and may be configured for movement with the glove 30 into a plurality of different positions relative to the NFC sensor module 20 of the power tool 10. As the NFC tag 31 moves in to the plurality of different positions, the NFC sensor module 20 is configured to sense a plurality of different sensor readings corresponding to each of the different positions. When the glove 30 is worn by a user's hand and is arranged to grip the handle 10a of the power tool 10 in a predetermined manner, the NFC sensor module 20 is proximate to the NFC tag 31 such that a first sensor reading is captured by the NFC sensor module 20. In this example, the predetermined manner of gripping the handle 10a of the power tool may be indicative of the safe way to grip the handle 10a. The first sensor reading indicates that the handle 10a of the power tool 10 is being properly gripped in a predetermined manner and orientation, and accordingly, the switch module 22c is arranged in to the closed state in response to the first sensor reading being read from the NFC sensor module 20 so that the power tool 10 is operable.

When the glove 30 is worn by the user's hand and is not arranged to grip the handle 10a in the predetermined proper manner, the NFC sensor module 20 is configured to capture a second sensor reading. The second sensor reading indicates that the handle 10a of the power tool 10 is not being properly gripped in the predetermined manner, and accordingly, the switch module 22c is arranged in to the opened state in response to the second sensor reading being read form the NFC sensor module 20 so that the power tool 10 is inoperable. Advantageously, this system may find application as a safety mechanism to ensure that a user of the electric power tool 10 is handling the electric power tool 10 in a predetermined safe manner—that is, by gripping the handle 10a of the power tool 10 according to the predetermined correct position, orientation, and (in some embodiments) a sequence and/or pattern of movement of the device, in order for the power tool 10 to be operable in a safe manner Such may be determined by the sensor module(s) of embodiments of the present disclosure and used as a reference to identify any potential safety issues in usage of the device. Additionally, in addition to the safety aspect, this feature of the disclosure may also encourage gripping of the handle 10a of the power tool 10 in a correct position, orientation, sequence and/or pattern of movement of the device so that the power tool 10 may be utilized in the most efficient and effective manner Yet further, this feature may also encourage users to wear gloves when operating certain electric power tools such as drills, saws and grinding type devices, so as to alleviate skin abrasions while operating such devices. In other embodiments, the glove may be used to grip a user-engagement surface of an electric device including a steering wheel.

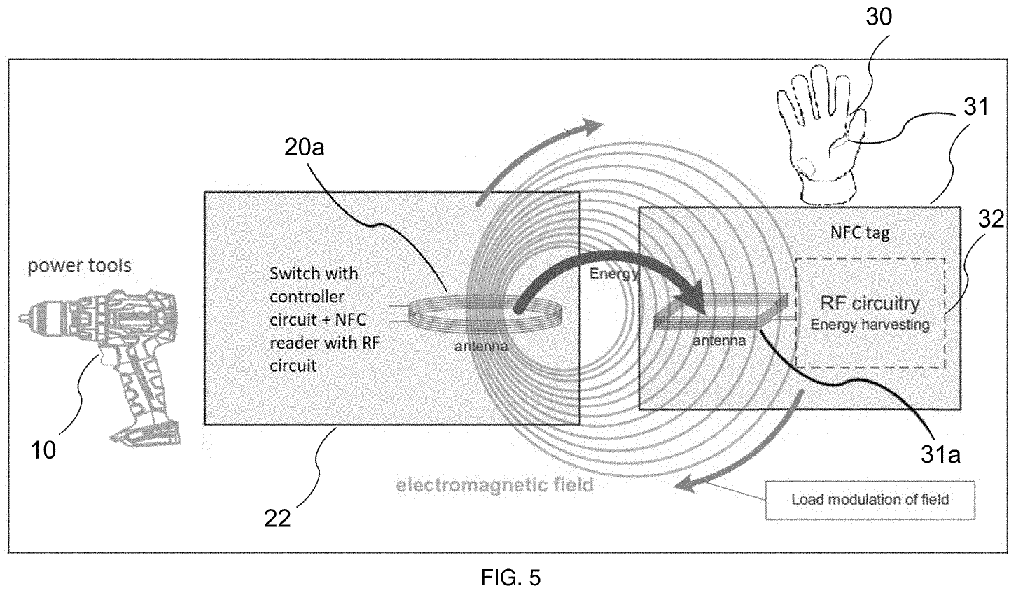

FIG. 5 shows a representation of the contactless interaction between the NFC sensor module and the NFC tag 31 of the electric device access control system 1, in accordance with at least one embodiment of the present disclosure. In the example shown in FIG. 5, a wearable item 30 is also provided in the form of a glove 30 having at least one sensor-readable element 31 disposed thereon. In other embodiments, the wearable item 30 could include for instance a bracelet, ring, watch, hat, shirt, or other wearable item. The sensor-readable element 31 in this embodiment includes a flexible planar NFC tag 31 having circuitry 32 formed therein which is configured for contactless interaction with the NFC sensor module 20 in the power tool 10 when the NFC tag 31 is within a predetermined proximity (e.g. typically 4-5 cm) from the NFC sensor module 20. The NFC tag 31 includes a data storage module containing encoded data indicative of an identification number of the NFC tag 31 amongst other things such that when the NFC tag 31 is read by the NFC sensor module 20, the identity number associated with the NFC tag 31 may be determined. The NFC sensor module 20 emits a small electric current which creates a magnetic field from an induction coil 20a which bridges the physical distance between the NFC sensor module 20 in the power tool 10 and the NFC tag 31 circuitry in the glove 30. The magnetic field is received by a similar induction coil 31a in the NFC tag 31 circuitry. Using the energy of the magnetic field (e.g., the load modulation of the field) received in to the NFC tag circuitry induction coil 31a, the NFC tag 31 circuitry is configured to communicate a signal back to the NFC sensor module 20 containing the identification number or other identifying information contained in the NFC tag 31. In this embodiment, the NFC tag 31 is a passive NFC device although in other embodiments, an active device such as an RFID tag or other identification device may be utilized having its own internal power source.

In certain embodiments, there may be multiple NFC tags disposed on different regions of the glove 30 each of which contactlessly interact with the NFC sensor module (or interact with different NFC sensor modules) in the manner described above. For instance, NFC tags may be disposed on each of the finger tips regions of the glove as well as the palm and heel regions of the glove. Advantageously, the use of multiple NFC tags allows for the position, configuration and orientation of the glove relative to the power tool handle to be determined with greater accuracy due to multiple points of reference of the glove being determinable by the NFC sensor module(s) 20 (see FIG. 4) of the controller module 22. In certain embodiments, the system maybe further configured such that in response to sensing one more of the NFC tags not being within a predetermined proximity to the handle of the power tool this may be indicative that the user is not safely holding the handle of the power tool in a correct predetermined orientation and with the a requisite predetermined grip, and consequently, the switch module may be configured to operate in the opened configuration to prevent power from the battery being delivered to the motor of the power tool so that it is inoperable.

In certain embodiments, the power tool 10 may still remain inoperable even when the power tool 10 is being gripped properly in the predetermined manner and configuration by the glove 30 and when the NFC tag 31 disposed on the glove 30 is in the first position relative to the NFC sensor module 20 disposed in the handle 10a of the power tool 10. Instead, the power tool 10 may only be rendered operable when a specific NFC tag 31 is sensed based on the unique identification number encoded in the NFC tag 31 being communicated to the NFC sensor module 20. In such alternate embodiments, the authentication module (22b in FIG. 4) of the control module 22 may be configured to sense whether the identification number information of the NFC tag communicated to the NFC sensor module 20 is one which is authorized to operate the power tool. When the authentication module 22b determines that the identification number read from the NFC sensor module 20 is authorized, the controller module 22 is configured to actuate the switch module 22c in to the closed operational state whereby the power tool 10 is operable. Conversely, when the authentication module 22b does not determine that the identification number information of the NFC tag 31 communicated to the NFC sensor module (20 in FIG. 4) is indicative of an authorized user, then the controller module 22 is configured to actuate the switch module 22c in to the opened operational state whereby power tool 10 is inoperable. Yet further, in certain embodiments, the authentication module 22b may be configured for programming by a user so that the identity of authorized users may be customized For instance, a user programming interface may be provided by way of suitable software running on a desktop computer which may be interfaced with the authentication module 22b of the controller module 22 in the power tool 10 via a USB cable linking the desktop computer and power tool 10, or, via a wireless communication protocol link (e.g. via a Bluetooth™ connection). Thus, one or more authorized users may be programmed in to the authentication module 22b so that when their NFC tag 31 with the corresponding identification number is sensed by the NFC sensor module 20, the power tool 10 is operable. Advantageously, this ensures that only certain users may be authorized to operate a specific power tool.

In certain embodiments, instead of restricting operation of the power tool entirely if the authentication module fails to sense an authorized identification number of the NFC tag, the power tool may still be configured for operation but at only restricted times of the day, or may be operable only at restricted speeds based upon the identification number sensed from the NFC tag by the NFC sensor module. Advantageously, this provides a safety mechanism for inexperienced users so that they may only operate the power tool at a predetermined safe level and only at times when there may be proper supervision.

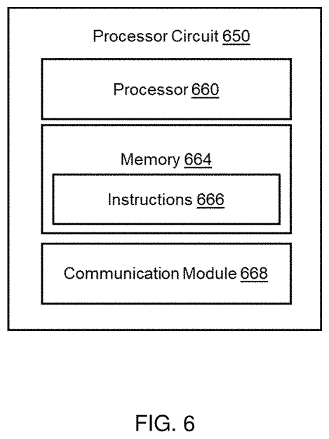

FIG. 6 is a schematic diagram of a processor circuit 650, according to embodiments of the present disclosure. The processor circuit 650 may be implemented in electric device access control system, or other devices or workstations (e.g., third-party workstations, network routers, etc.), or on a cloud processor or other remote processing unit, as necessary to implement methods of the systems described herein. As shown, the processor circuit 650 may include a processor 660, a memory 664, and a communication module 668. These elements may be in direct or indirect communication with each other, for example via one or more buses.

The processor 660 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 660 may also comprise another hardware device, a firmware device, or any combination thereof configured to perform the operations described herein. The processor 660 may also be implemented as a combination of computing devices, e.g., a combination of a DSP and a microprocessor, a plurality of microprocessors, one or more microprocessors in conjunction with a DSP core, or any other such configuration.

The memory 664 may include a cache memory (e.g., a cache memory of the processor 660), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 664 includes a non-transitory computer-readable medium. The memory 664 may store instructions 666. The instructions 666 may include instructions that, when executed by the processor 660, cause the processor 660 to perform the operations described herein. Instructions 666 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 668 can include any electronic circuitry and/or logic circuitry to facilitate direct or indirect communication of data between the processor circuit 650, and other processors or devices. In that regard, the communication module 668 can be an input/output (I/O) device. In some instances, the communication module 668 facilitates direct or indirect communication between various elements of the processor circuit 650 and/or the electric device access control system. The communication module 668 may communicate within the processor circuit 650 through numerous methods or protocols. Serial communication protocols may include but are not limited to US SPI, I²C, RS-232, RS-485, CAN, Ethernet, ARINC 429, MODBUS, MIL-STD-1553, or any other suitable method or protocol. Parallel protocols include but are not limited to ISA, ATA, SCSI, PCI, IEEE-488, IEEE-1284, and other suitable protocols. Where appropriate, serial and parallel communications may be bridged by a UART, USART, or other appropriate subsystem.

External communication (including but not limited to software updates, firmware updates, preset sharing between the processor and central server, or readings from the electric device access control system) may be accomplished using any suitable wireless or wired communication technology, such as a cable interface such as a USB, micro USB, Lightning, or FireWire interface, Bluetooth, Wi-Fi, ZigBee, Li-Fi, or cellular data connections such as 2G/GSM, 3G/UMTS, 4G/LTE/WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

Depending on the implementation, other wearable items may be employed besides a glove, including but not limited to hats, rings, bracelets, eyeglasses, shirts, buckles, or watches. As will be readily appreciated by those having ordinary skill in the art after becoming familiar with the teachings herein, many different sensor types and sensor-readable element types could be used instead of or in addition to those described herein. Accordingly, it can be seen that the electric device access control system fills a long-standing need in the art, by providing a mechanism to limit access to an electrical device by untrained, unskilled, or unauthorized users. A number of variations are possible on the examples and embodiments described above. For example, motions or poses of the wearable item may be detected, and may in some embodiments be required in order to enable the electrical device. Employed for vehicles, heavy equipment, or appliances. The technology described herein may be applied in a variety of industries, including but not limited to construction, demolition, mining, transportation, medicine, art, and banking.

Accordingly, the logical operations making up the embodiments of the technology described herein are referred to variously as operations, steps, objects, elements, components, or modules. Furthermore, it should be understood that these may be performed in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the electric device access control system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the electric device access control system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system for controlling operation of an electric device, the system including:
an electric device;
at least one contactless-type sensor operably connected to the electric device;
a wearable item having at least one sensor-readable element disposed therein, said sensor-readable element being configured for contactless interaction with the at least one contactless-type sensor of the electric device;
said at least one sensor-readable element being configured for movement with the wearable item into a plurality of different positions relative to the at least one contactless-type sensor of the electric device, whereby the at least one contactless-type sensor is configured to sense a plurality of different sensor readings in response to movement of the at least one sensor-readable element into the plurality of different positions; and
wherein the electric device is configured to enter a first operating mode in response to the at least one contactless-type sensor sensing a first sensor reading when the at least one sensor-readable element is arranged in a first position relative to the at least one contactless-type sensor, and wherein, the electric device is configured to enter a second operating mode in response to the at least one contactless-type sensor sensing a second sensor reading when the at least one sensor-readable element is arranged in a second position relative to the at least one contactless-type sensor.

2. A system as claimed in claim 1, wherein the first operating mode comprises normal operation of the electric device, and the second operating mode comprises non-operation of the electric device.

3. A system as claimed in claim 1, wherein when the at least one sensor-readable element is arranged in the first position relative to the at least one contactless-type sensor, the wearable item is engaged with a user-engagement portion of the electric device in a predetermined configuration, and, when the at least one sensor-readable element is arranged in the second position relative to the at least one contactless-type sensor, the wearable item is not engaged with the user-engagement portion of the electric device in the predetermined configuration.

4. A system as claimed in claim 3, wherein the user-engagement portion includes a handle of the electric device.

5. A system as claimed in claim 1, wherein the electric device includes at least one of an electric power tool, an electric gardening tool or a vehicle.

6. A system as claimed in claim 1, wherein the wearable item includes at least one of a glove, a bracelet, a ring, a hat, a shirt, or a watch.

7. A system as claimed in claim 1, wherein the wearable item includes a plurality of sensor-readable elements disposed thereon and the electric device includes a plurality of corresponding contactless-type sensor modules operably-connected therewith.

8. A system as claimed in claim 1, wherein the contactless-type sensor is operably-connected with a switch module of the electric device, said switch module being operable in a first operational state responsive to the at least one contactless-type sensor sensing the first sensor reading whereby power from a power supply of the electric device is able to be delivered to an electric motor of the electric device via the switch module so that the electric device is operable, and a second operational state responsive to the at least one contactless-type sensor sensing the second sensor reading whereby power from the power supply of the electric device is not able to be delivered to the electric motor of the electric device via the switch module.

9. A system as claimed in claim 1, wherein the at least one contactless-type sensor includes a Near Field Communication (NFC) type sensor.

10. A system as claimed in claim 1, wherein the sensor-readable element is disposed in a tag disposed on the wearable item.

11. A system as claimed in claim 10, wherein the tag is removably attachable to the wearable item.

12. A system as claimed in claim 1, wherein the first sensor reading is sensed by the at least one contactless-type sensor when both the at least one sensor-readable element is arranged in the first position relative to the at least one contactless-type sensor, and, when the at least one contactless-type sensor reads an identification data stored in the at least one sensor-readable element and an authentication module operably connected with the at least one contactless-type sensor determines that the identification data meets a predetermined criterion.

13. A system as claimed in claim 12, wherein the authentication module is programmable to customise the predetermined criterion.

14. A system as claimed in claim 2, wherein, when the electric device is configured to be in first or second operating mode, the electric device is configured to be in the first or second operating mode for a specific time period.

15. The system of claim 1, wherein the first or second operating mode comprises non-operation of selected features of the electric device.

16. A wearable item for use in controlling operation of an electric device wherein:
at least one contactless-type sensor is operably connected with the electric device;
at least one sensor-readable element is disposed on the wearable item, said sensor-readable element being configured for contactless interaction with the at least one contactless-type sensor of the electric device;
said at least one sensor-readable element being configured for movement with the wearable item into a plurality of different positions relative to the at least one contactless-type sensor of the electric device whereby the at least one contactless-type sensor is configured to sense a plurality of different sensor readings in response to movement of the at least one sensor-readable element into the plurality of different positions; and
wherein the electric device is configured to be in a first operating mode in response to the at least one contactless-type sensor sensing a first sensor reading when the at least one sensor-readable element is arranged in a first position relative to the at least one contactless-type sensor, and wherein, the electric device is configured to be in a second operating mode in response to the at least one contactless-type sensor sensing a second sensor reading when the at least one sensor-readable element is arranged in a second position relative to the at least one contactless-type sensor.

17. An electric device controllable by a wearable item, the electric device including at least one contactless-type sensor is operably-connected therewith, wherein:
at least one sensor-readable element is disposed on the wearable item, said sensor-readable element being configured for contactless-interaction with the at least one contactless-type sensor of the electric device;
said at least one sensor-readable element being configured for movement with the wearable item into a plurality of different positions relative to the at least one contactless-type sensor of the electric device whereby the at least one contactless-type sensor is configured to sense a plurality of different sensor readings in response to movement of the at least one sensor-readable element into the plurality of different positions; and
wherein the electric device is configured to be in a first operating mode in response to the at least one contactless-type sensor sensing a first sensor reading when the at least one sensor-readable element is arranged in a first position relative to the at least one contactless-type sensor, and wherein, the electric device is configured to be in a second operating mode in response to the at least one contactless-type sensor sensing a second sensor reading when the at least one sensor-readable element is arranged in a second position relative to the at least one contactless-type sensor.

18. A non-transitory computer-readable storage medium storing instructions, which when executed by at least one processor of a computer system, causes the computer system to carry out the sensing and entering steps of the system of claim 1.

19. A computer-readable medium carrying instructions, which when executed by at least one processor of a computer system, causes the computer system to carry out the sensing and entering steps of the system of claim 1.

20. A computer system comprising:
one or more processors; and
a storage medium storing instructions, which when executed by at least one processor, cause the system to implement the sensing and entering steps of the system of claim 1.
